(19) United States
(12) Patent Application Publication
(10) Pub. No.: US 2019/0187601 A1
(43) Pub. Date: Jun. 20, 2019

(54) ABNORMALITY DETERMINATION APPARATUS, IMAGE FORMING APPARATUS, ABNORMALITY DETERMINATION SYSTEM, AND PROGRAM

(71) Applicant: KONICA MINOLTA, INC., Tokyo (JP)

(72) Inventors: Hirotada SEKI, Toyokawa-shi (JP); Hiroshi EGUCHI, Toyohashi-shi (JP); Natsuyo IDA, Toyokawa-shi, (JP); Junichi MASUDA, Toyokawa-shi (JP); Masahiro NONOYAMA, Toyokawa-shi (JP); Akimasa ISHIKAWA, Toyokawa-shi (JP)

(73) Assignee: KONICA MINOLTA, INC., Chiyoda-ku, Tokyo (JP)

(21) Appl. No.: 16/212,684

(22) Filed: Dec. 7, 2018

(30) Foreign Application Priority Data
Dec. 20, 2017 (JP) 2017-244079

(51) Int. Cl. G03G 15/00; H04R 1/08

(52) U.S. Cl. CPC G03G 15/55; G03G 21/0011; H04R 1/08

(57) ABSTRACT

An abnormality determination apparatus includes: an audio data acquisitor that acquires audio data of an apparatus to be judged for determining presence or absence of abnormality; an abnormal sound detector that detects an abnormal sound based on the audio data acquired by the audio data acquisitor; and a hardware processor that determines whether the abnormal sound is such a sound that an operation of the apparatus to be judged should be restricted based on a subsequent secular change of the abnormal sound when the abnormal sound is detected by the abnormal sound detector, and restricts the operation of the apparatus to be judged when the hardware processor determines that the abnormal sound is such a sound that the operation of the apparatus to be judged should be restricted.

The entire disclosure of Japanese patent Application No. 2017-244079, filed on Dec. 20, 2017, is incorporated herein by reference in its entirety.

### BACKGROUND

### Technological Field

The present invention relates to an abnormality determination apparatus used for determining presence/absence of abnormality of an apparatus to be judged such as an image forming apparatus by sound, an image forming apparatus including the abnormality determination apparatus, an abnormality determination system, and a program.

### Description of the Related art

In an image forming apparatus such as a multi function peripheral (MFP) or the like which is a multifunctional digital image forming apparatus, and other apparatuses, abnormal sounds are likely to occur during the operation when the life span end of a component is approaching.

Therefore, a technique is known in which abnormality of an apparatus to be judged such as an image forming apparatus is determined by sound and the operation of the apparatus is controlled based on the determination result. For example, JP 2016-022619 A proposes a method of estimating the life span of component generating an abnormal sound according to the loudness of the sound and determining that the sound is an abnormal sound when the sound exceeds the sound pressure level of a predetermined threshold value, and it has been proposed to restrict the operation of the component having abnormality if it is determined that the sound is an abnormal sound.

Further, in JP 2012-177748 A, a technique has been proposed in which an apparatus has a conversion memory between loudness of an abnormal operation sound and replacement timing for components, and compares the operating sound over time with the past data, thereby collating the sound with the abnormal operation sound stored in a memory for known abnormal sounds if it is determined that the operation sound has a sign of abnormality, and notifying about the replacement timing of the component based on the result of matching as to a component and a replacement timing in the conversion memory.

However, even if an abnormal sound occurs once, the abnormal sound may be an abnormal sound due to other noises. Further, depending on the loudness or occurrence frequency of abnormal sounds, there are cases in which the component can still be used. Therefore, when the operation of the apparatus to be judged is restricted or a component is replaced based only on the occurrence of an abnormal sound as in the techniques described in JP 2016-022619 A and JP 2012-177748 A, there is a problem that the running cost is increased and at the same time the downtime of the apparatus becomes long.

### SUMMARY

The present invention has been made in view of such a technical background, and an object is to provide an abnormality determination apparatus, an image forming apparatus, an abnormality determination system and a program, which can solve problems such as an increase in running cost and long downtime of the apparatus to be judged, which are caused by restricting the operation of an apparatus to be judged on the basis of only occurrence of an abnormal sound, in the case of detecting the presence or absence of abnormality of an apparatus to be judged such as the image forming apparatus based on the abnormal sound.

To achieve the abovementioned object, according to an aspect of the present invention, an abnormality determination apparatus reflecting one aspect of the present invention comprises: an audio data acquisitor that acquires audio data of an apparatus to be judged for determining presence or absence of abnormality; an abnormal sound detector that detects an abnormal sound based on the audio data acquired by the audio data acquisitor; and a hardware processor that determines whether the abnormal sound is such a sound that an operation of the apparatus to be judged should be restricted based on a subsequent secular change of the abnormal sound when the abnormal sound is detected by the abnormal sound detector, and restricts the operation of the apparatus to be judged when the hardware processor determines that the abnormal sound is such a sound that the operation of the apparatus to be judged should be restricted.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram of an image forming apparatus in which an abnormality determination apparatus according to an embodiment of the present invention is used;

FIG. 2 is a diagram showing a configuration example of a photoreceptor drum unit;

FIG. 3 is a block diagram showing an electrical configuration of an image forming apparatus;

FIG. 4 is a graph showing a relationship between an operation time and a sound pressure level at a certain frequency (frequency caused by deterioration of a member to he detected) of an image forming apparatus;

FIG. 5 is a graph showing the relationship between the operation time and the sound pressure level of the image forming apparatus when the operation restriction is performed because the abnormal sound of the audio data is determined to be due to the deterioration of the cleaning blade;

FIG. 6 is a graph for illustrating an example in which deterioration of a cleaning blade is judged based on the occurrence frequency of an abnormal sound;

FIG. 7 is similarly a graph for illustrating an example in which deterioration of a cleaning blade is judged based on the occurrence frequency of an abnormal sound;

FIG. 8A is a graph showing frequency and a sound pressure level at the time of initial operation of the cleaning blade;

FIG. 8B is a graph showing the frequency and sound pressure level when the deterioration is small;

FIG. 8C is a graph showing the frequency and sound pressure level when the deterioration is large;

FIG. 9 is a flowchart showing an operation example of the image forming apparatus when an abnormal sound is detected;

FIG. 10 is a flowchart showing another operation example of the image forming apparatus when an abnormal sound is detected;

FIG. 11 is a configuration diagram of an abnormality determination system including the image forming apparatus and a management apparatus; and

FIG. 12 is a block diagram showing an electrical configuration of the management apparatus.

### DETAILED DESCRIPTION OF EMBODIMENTS

Hereinafter, one or more embodiments of the present invention will be described with reference to the drawings. However, the scope of the invention is not limited to the disclosed embodiments.

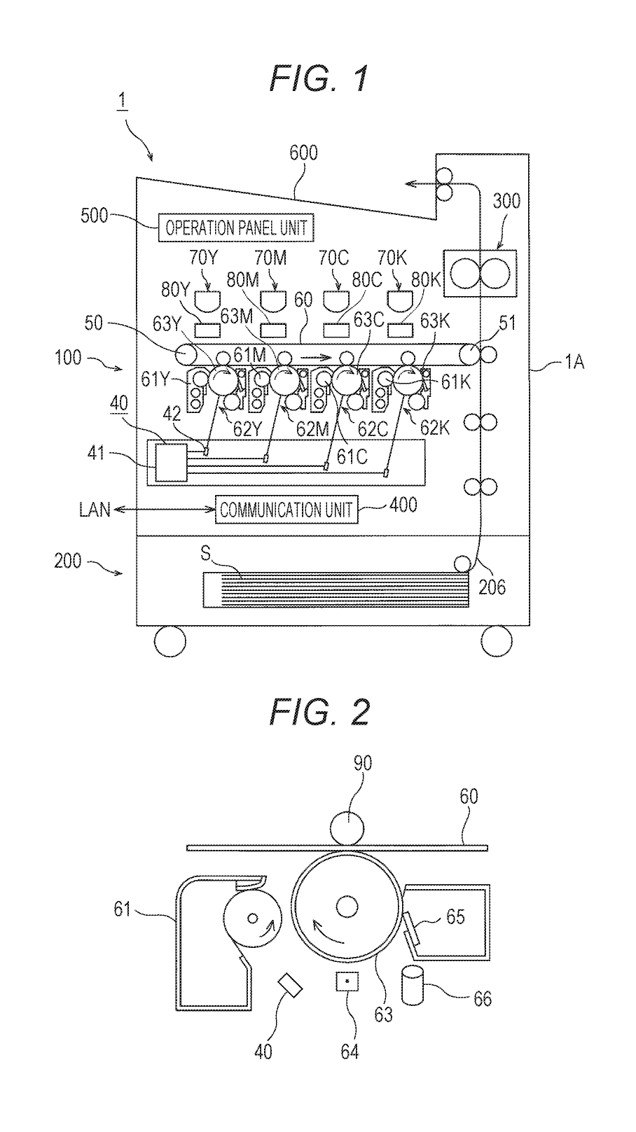

FIG. 1 is a schematic configuration diagram of an image forming apparatus 1 as an example of an abnormality determination apparatus according to an embodiment of the present invention. In this example, a tandem type color printer is used as the image forming apparatus 1.

In FIG. 1, the image forming apparatus 1 includes a sheet feeding unit 200 arranged in the lower part of an apparatus main body 1A, color image forming unit 100 in the middle part, and sheet discharging unit 600 in the upper part. A sheet conveyance path 206 is provided from the sheet feeding unit 200 to the sheet discharging unit 600, for conveying a sheet (paper) S fed from the sheet feeding unit 200 upward.

The color image forming unit 100 includes a driving roller 51 and a driven roller 50 disposed substantially in the center in the vertical direction oldie apparatus main body 1A, an intermediate transfer belt 60 suspended horizontally between these driving and driven rollers 51 and 50 for traveling in the direction of the arrow, and photoreceptor units 62Y, 62M, 62C, and 62K, which are image forming units of yellow (Y), magenta (M), cyan (C), and black (K) arranged in this travel direction.

The toner images formed by the photoreceptor units 62Y, 62M, 62C, and 62K are superimposed and transferred to the transfer belt 60, and subjected to a second transfer on the sheet S conveyed on the sheet conveyance path 206 at the conveyance end of the transfer belt 60 (the right end in the figure), and the sheet S is fed to a fixing unit 300 so that the toner images are fixed.

The photoreceptor units 62Y, 62M, 62C, and 62K form images by an electrostatic copying method, and include respectively chargers, developing devices 61Y, 61M, 61C, and 61K, photoreceptor drums 63Y, 63M, 63C, and 63K, and transfer devices or the like disposed on the periphery of each of the photoreceptor units. In addition, the surface of each of photoreceptor drums 63Y, 63M, 63C, and 63K charged by the charger is exposed with each of the laser diodes of an exposure unit 40 including a print head 41 having four laser diodes, a polygon mirror, a scanning lens, etc., and four reflection mirrors 42 and the like so that an electrostatic latent image is formed on the surface.

Further, toner cartridges 70Y, 70M, 70C, and 70K and sub-hoppers 80Y, 80M, 80C, and 80K are disposed above the photoreceptor units 62Y, 62M, 62C, and 62K as replenishing mechanisms for replenishing toner to the developing devices 61Y, 61M, 61C, and 61K of the respective photoreceptor units 62Y, 62M, 62C, and 62K.

In FIG. 1, reference numeral 400 denotes a communication unit with an external apparatus, and reference numeral 500 denotes an operation panel unit having a key unit and a display unit.

FIG. 2 is a configuration diagram of each photoreceptor unit 62 (62Y, 62M, 62C, or 62K). Each photoreceptor unit 62 includes an electrification charger 64 (64Y, 64M, 64C, or 64K), the developing device 61 (61Y, 61M, 61C, or 61K), a cleaning blade 65 (65Y, 65M, 65C, or 65K) as a cleaning device for removing the toner remaining on the photoreceptor drum 63, with the photoreceptor drum 63 (63Y, 63M, 63C, or 63K) located in the center, and a sound detection unit (audio data acquiring unit) 66 (66Y, 66M, 66C, or 66K) made of a microphone is arranged in the vicinity of each cleaning blade 65. After the photoreceptor drum 63 is charged by the electrification charger 64, the electrostatic latent image drawn on the photoreceptor drum 63 by the laser beam emitted from the exposure unit 40 which is a laser scanning optical unit is developed to form toner images of respective colors by moving negatively charged toner from the developing device 61 to the photoreceptor drum 63.

The toner images formed on the surfaces of the photoreceptor drums 63 are primarily transferred onto the intermediate transfer belt 60 and synthesized by the electric field applied from primary transfer rollers 90 facing respective photoreceptor drums 63.

Such an electrophotographic image forming process is well known, and a detailed description thereof will be omitted.

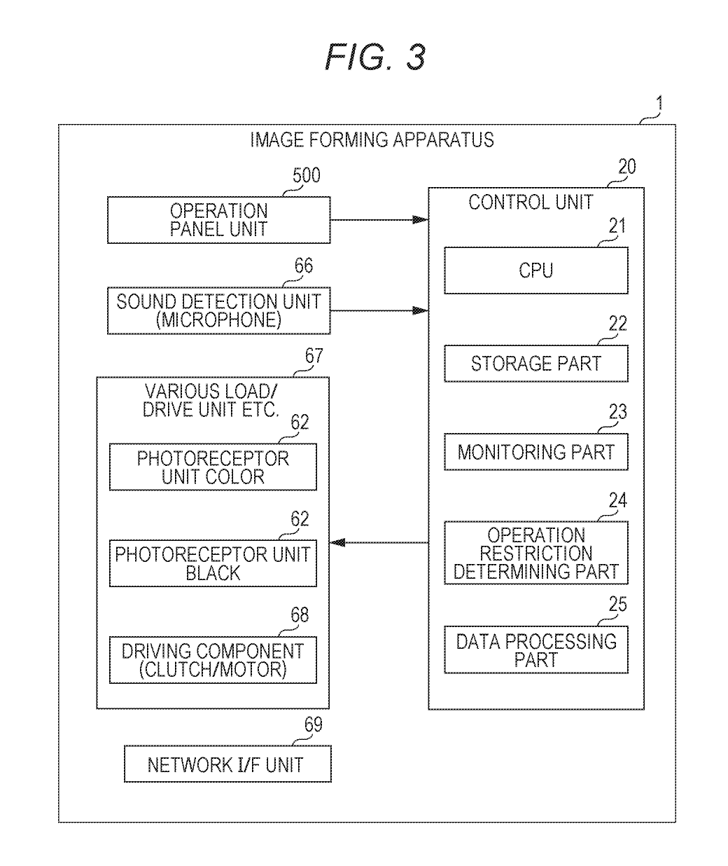

FIG. 3 is a block diagram showing an electrical configuration of the image forming apparatus 1. The image forming apparatus 1 includes a control unit 20, the above-described operation panel unit 500, the above-described sound detection unit 66, a various load/drive unit 67, a network interface unit (network I/F unit) 69, and the like.

The control unit 20 comprehensively controls various loads in the image forming apparatus 1, and includes a CPU 21 serving as a computing unit, a storage part (ROM/RAM/nonvolatile flash memory or the like) 22, a monitoring part 23 that monitors the presence or absence of occurrence of an abnormal sound and the secular change after the occurrence as well as audio data and determines whether the abnormal sound is such a sound that the operation of the image forming apparatus 1 should be restricted based on the secular change after the occurrence of the abnormal sound, in other words, whether the abnormal sound is a sound by which deterioration of a component of the audio data acquisition target can be estimated, an operation restriction determining part 24 for determining whether to restrict the operation of the image forming apparatus 1 based on the determination result by the monitoring part 23, a data processing part 25, and the like. The monitoring part 23, the operation restriction determining part 24, and the data processing part 25 are configured as functions of the CPU 21.

In the nonvolatile flash memory or the like of the storage part 22, audio data, a level of an abnormal sound, audio data for collation for determining that the abnormal sound is caused by deterioration of the target component, a program and the like are stored, and the monitoring part 23 compares the audio data with a level of the abnormal sound and audio data for collation to determine whether the sound is an abnormal sound and whether the sound is such an abnormal sound that the operation should be restricted.

The audio data of the sound generated by the machine (component) acquired by the sound detection unit 66 is sent to the control unit 20, converted to data for storage by the data processing part 25, and then stored in the storage part 22. Accordingly, in the storage part 22, the audio data generated from the time of the initial operation of the machine (component) is stored with the lapse of time.

As the various load/drive unit 67, the above-described photoreceptor unit (color and monochrome) 62, and driving component 68 such as a clutch and a motor are included.

The network I/F unit 69 constitutes the aforementioned communication unit 400 (shown in FIG. 1) for exchanging data with an external apparatus, namely a management apparatus for example to be described later or the like.

Next, the operation of the image forming apparatus 1 when an abnormal sound is detected from the audio data acquired by the sound detection unit 66 and stored in the storage part 22 will be described. In the present embodiment, the case where the acquisition target of the audio data is the cleaning blade 65 will be described, but the target is not limited to the cleaning blade 65.

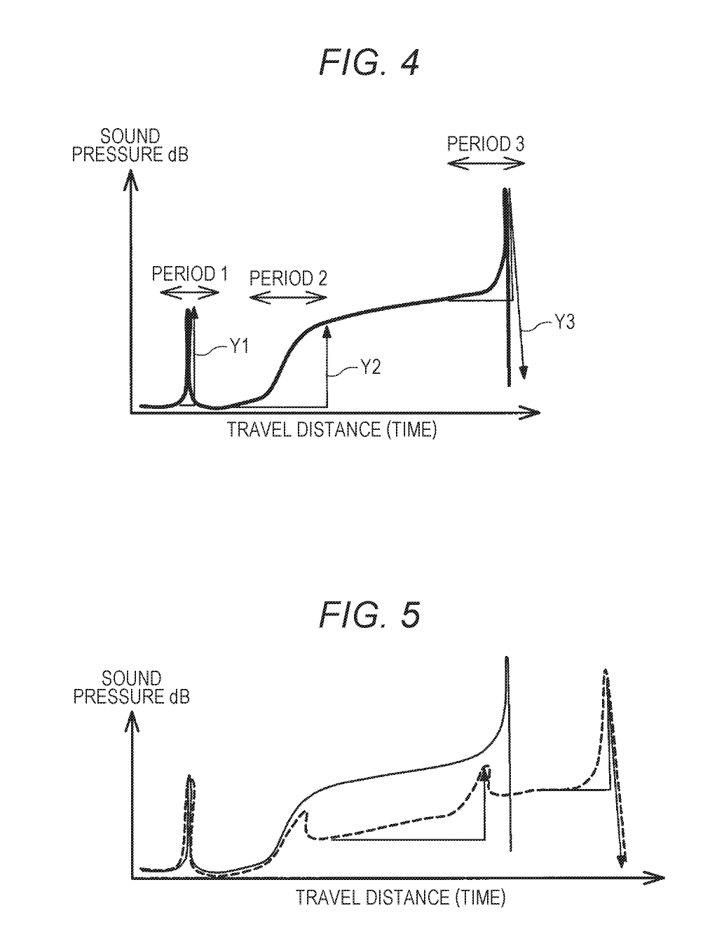

FIG. 4 is a graph showing the relationship between operating time (indicated as a travel distance (time) FIG. 4) and a sound pressure level of the image forming apparatus 1 at a certain frequency (frequency caused by deterioration of the cleaning blade 65 in this example).

The operation sound of the machine is continuously acquired by the sound detection unit 66 for the entire time during the operation of the detection target (the cleaning blade 65 in this example), and the acquired audio data is processed by the data processing part 25 into sound pressure level data and stored in the storage part 22. In addition, the sound pressure level of the abnormal sound caused due to abrasion or deterioration is stored in the storage part 22 in advance as a predetermined value.

In the period 1 in the graph of FIG. 4, the sound pressure level sharply rises as indicated by the arrow Y1, and a high value is detected as the sound pressure level, but since the abnormal sound occurs abruptly without a sign in continuous measurement, and the level has dropped after the occurrence to the same level as before the occurrence, the monitoring part 23 determines that this abnormal sound is caused by abnormality which is not deterioration (external noise), and the operation restriction determining part 24 follows the determination result to determine not to restrict the image forming operation.

In the period 2, when an abnormal sound having a high sound pressure level is measured as indicated by arrow Y2, the monitoring part 23 monitors the subsequent secular change of the audio data. In this example, since the sound pressure level also increases as the travel distance increases, the monitoring part 23 determines that this abnormal sound is a sound caused by degradation of the cleaning blade 65. As described above, the audio data for collation, which is the criterion of judgment, is stored in the storage part 22, and the monitoring part 23 compares the secular changes of the audio data after the occurrence of the abnormal sound with the data for collation to determine whether the sound is an abnormal sound due to deterioration of component based on the collation result.

For example, in the case of the cleaning blade 65, as the cleaning blade 65 is used, the edge abrasion proceeds and the contact area between the cleaning blade 65 and the photoreceptor drum 63 increases, so that the frictional force between the cleaning blade 65 and the photoreceptor drum 63 increases, and a frictional sound is generated as an abnormal sound. When it is determined that the abnormal sound is caused by the deterioration of the cleaning blade 65, the operation restriction determining part 24 determines to perform an operation restriction as described later, and the CPU 21 performs operation restriction based on this determination. Note that the level of restriction of operation is desirably changed while the timing of the operation restriction is switched according to the level change of the sound.

The period 3 in FIG. 4 is a period in a state where the deterioration of the cleaning blade 65 is already detected due to an abnormal sound, and after a sudden increase in sound, the sound pressure level sharply drops as compared with that before the sudden increase in sound as shown by an arrow Y3. This is probably because the cleaning blade 65 has been curled. Therefore, when detecting a sound (second sound) having a different sound quality, in the period 3, from the abnormal sound (first sound) in the period 2, the monitoring part 23 determines that the sound is abnormal because the deterioration of the cleaning blade 65 has advanced, and the operation restriction determining part 24 decides to prohibit the operation, whereby the CPU 21 prohibits the operation in accordance with this determination.

The audio data should be desirably acquired until at least the sound corresponding to the blade curling of the cleaning blade 65 is detected. As a result, the cleaning blade 65 can be used until its life span end is reached. In addition, although the audio data may be acquired for the entire time during the image forming operation, there may be a period during which the audio data is not acquired as long as the audio data to such a degree that the secular change from the occurrence of an abnormal sound to the blade curling can be estimated is acquired even if the audio data is not always acquired.

In this manner, when an abnormal sound by which the operation is determined to be restricted based on the secular change after the detection is assumed to be the first sound, the operation is restricted due to the first sound so that the restriction level of the operation is changed according to the level change of the sound after the abnormal sound detection and the operation is prohibited when the second sound having a sound quality different from that of the first sound is detected, whereby the presence of deterioration of the cleaning blade 65 which has generated an abnormal sound can be more accurately determined and the operation according to the degree of deterioration of the component can be performed.

Further, not only in the cleaning blade 65 but also in the electromagnetic clutch, abrasion of the bearing portion and the friction surface proceeds as the coupling/release/rotation is carried out, so that an offset (eccentricity) of rotation occurs, and as a result, an abnormal sound is generated due to abnormal contact at a place inside the clutch which has originally no contact, or abnormality of engagement between the clutch and the gear. Also in this case, since the sound pressure level increases with age as in the period 2 in FIG. 4, presence of the deterioration can be determined based on the result of continuous measurement.

FIG. 5 is a graph showing the relationship between the operation time and the sound pressure level of the image forming apparatus 1 when the operation restriction is performed since it is determined that the abnormal sound of the audio data is due to the deterioration of the cleaning blade 65.

When it is determined that the cleaning blade 65 has deteriorated based on the detection of the abnormal sound and the subsequent secular change in the period 2 illustrated in FIG. 4, the operation restriction determining part 24 determines to lower the rotation speed (productivity) of the photoreceptor drum 63 for example, and as a result, permits the image forming apparatus 1 to operate under the restriction when it is confirmed that the sound pressure level has decreased as indicated by the broken line in FIG. 5.

Also, when deterioration is confirmed again due to a sudden rise of the sound, the operation restriction determining part 24 determines restrictions such as a further reduction in productivity. In the case where the selectable restriction no longer exists or a sudden drop in the sound like the period 3 in FIG. 4 is detected, the operation restriction determining part 24 prohibits the printing operation affecting the cleaning of the photoreceptor drum 63, and permits only operations such as scanner operation for document reading which does not affect the cleaning of the photoreceptor drum 63.

Restrictions other than the decrease in productivity is considered to include print color restriction (monochrome, two color printing only), photo print restriction (character print is allowed), resolution restriction and the like.

As shown by the broken line in FIG. 5, by restricting the operation when an abnormal sound due to the deterioration of the cleaning blade 65 is detected, the travel distance (running time) until the cleaning blade 65 curls, in other words, the life span can be lengthened.

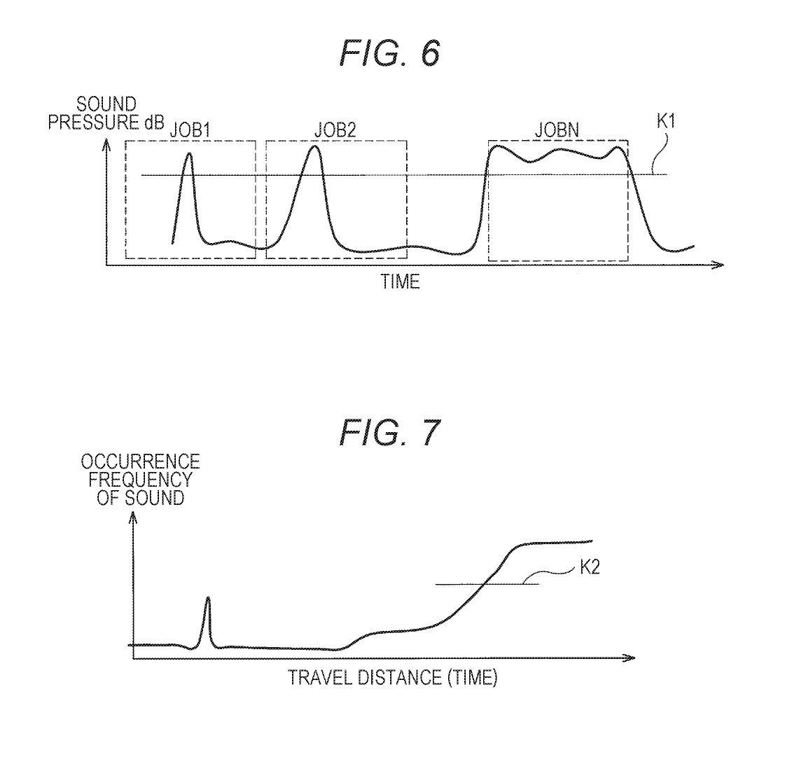

FIGS. 6 and 7 illustrate judgment of the deterioration of the cleaning blade 65 based on the occurrence frequency of the abnormal sound.

As shown in FIG. 6, the measurement period is determined to be one job (JOB). The period of each job is indicated by a dashed rectangle in FIG. 6. Then, within the time of each job, the period of time when the predetermined value K1 of the sound pressure level stored in the storage part 22 is exceeded is measured. For example, it is determined that

when the predetermined value is exceeded for one second out of ten seconds within the period of JOB 1, the value is 10%,

when the predetermined value is exceeded for two seconds out of ten seconds within the period of JOB 2, the value is 20%, and

when the predetermined value is exceeded for ten seconds out of ten seconds within the period of JOB N, the value is 100%, and

the result obtained by measuring the values with age is shown in the graph of FIG. 7.

In the graph of FIG. 7, the horizontal axis represents the operation time (travel distance (time)) of the image forming apparatus 1, and the vertical axis represents occurrence frequency. A change in the occurrence frequency of the sound pressure level exceeding the predetermined value as shown in the graph of FIG. 7, is compared with the threshold value K2, so that similarly to the case described with reference to FIGS. 4 and 5, when the occurrence frequency has reached K2, the sound is detected as an abnormal sound, and the secular change of occurrence frequency after that is checked, whereby whether the sound is an abnormal sound due to deterioration of the cleaning blade 65 is checked based on whether the occurrence frequency gradually increases, or the like, so that execution of the operation restriction is determined if the sound is an abnormal sound due to deterioration, and control is performed according to the determination result.

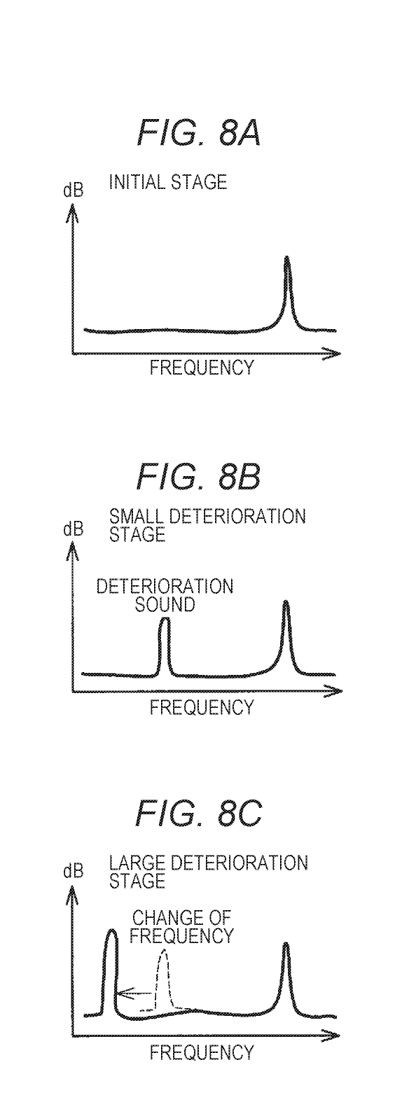

FIG. 8A is a graph showing a frequency and the sound pressure level at the time of initial operation of the cleaning blade 65, FIG. 8B is a graph showing the frequency and sound pressure level when the deterioration is small, and FIG. 8C is a graph showing the frequency and sound pressure level when the deterioration is large. At the initial stage of operation, only a frequency generated as a normal machine operation sound is measured as shown in FIG. 8A, but as deterioration starts, an abnormal sound (deterioration sound) having a high sound pressure level is detected in another frequency range different from that of the usual sound as shown in FIG. 8B. As the deterioration proceeds, the shift of frequency of the sound generated by the deterioration toward the lower side as shown in FIG. 8C is measured over time, and the operation restriction is determined to be performed and controlled as described above. Also in this case, the timing may be switched depending on the degree of degradation and stepwise operation restriction may be performed.

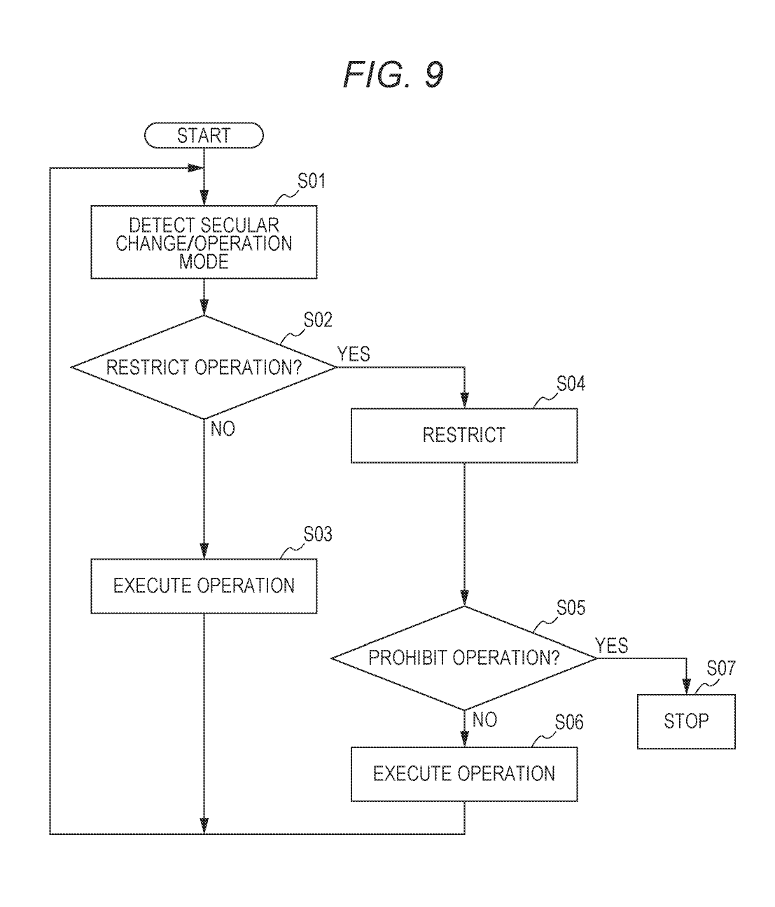

FIG. 9 is a flowchart showing the operation of the image forming apparatus 1 when an abnormal sound is detected. This operation is executed by the CPU 21 of the control unit 20 of the image forming apparatus 1 operating according to the operation program stored in the storage part 22 or the like.

After detecting the secular change of the abnormal sound and the operation mode of the apparatus itself in step S01, whether the abnormal sound is due to the deterioration of the component of the audio data acquisition target, in other words, whether the operation of the apparatus itself is to be restricted is determined in step S02. When the abnormal sound is not due to deterioration and the operation of the apparatus itself does not need to be restricted (NO in step S01), the operation is executed in step S03, and the processing returns to step S01 to detect an abnormal sound.

In step S02, when the abnormal sound is due to the deterioration of the component of the audio data acquisition target and the operation of the apparatus itself needs to be restricted (YES in step S02), execution of the operation restriction of the apparatus is determined in step S04, and the processing proceeds to step S05.

In step S05, it is determined whether the operation is to be prohibited, and when the operation is not prohibited (NO in step S05), the restricted operation is executed in step S06, and the processing returns to step S01. When the operation is prohibited (YES in step S05), the operation is stopped in step S07.

In the case where an abnormal sound is detected and operation is prohibited in the middle of the image forming operation (printing operation) based on the subsequent secular change, the number of unfinished sheets not primed is also considered as a basis for judgement as to whether to prohibit operation. To be specific, when the number of unfinished sheets is small, printing is continued without prohibiting and printing is prohibited after the printing completion, so that usability is not deteriorated for the user. When the number of unfinished sheets is large, the printing is prohibited immediately.

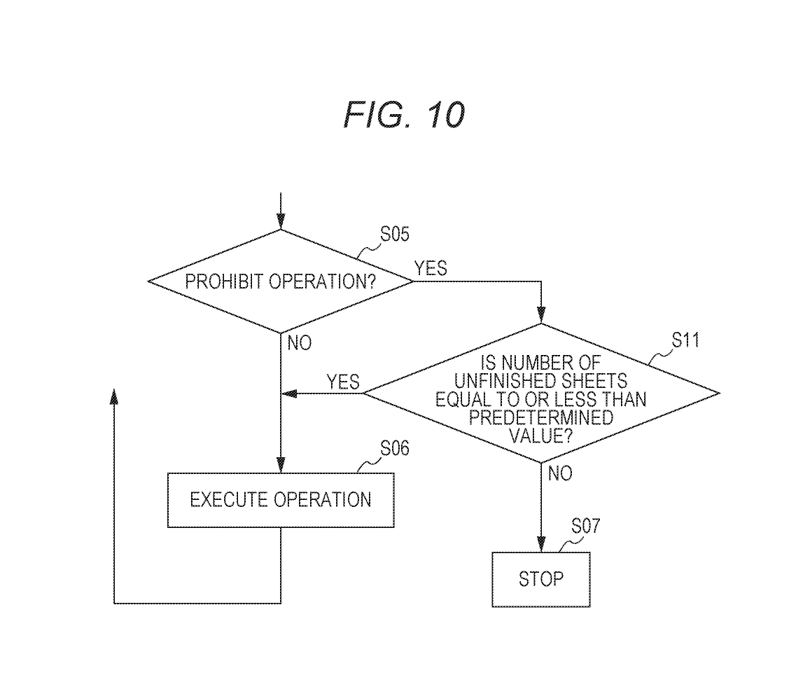

FIG. 10 is a flowchart showing the operation in the case where the number of unfinished sheets which are not printed is also taken into consideration as a material for judging whether to prohibit operation.

The flowchart shown in FIG. 10 shows the processing after step S05 in the flowchart of FIG. 9, and steps S01 to S04 are the same as in the flowchart of FIG. 9, so that the steps are omitted in FIG. 10.

In step S05, whether the operation is prohibited is determined, and when the operation is not prohibited (NO in step S05), the restricted operation is executed in step 506, and the processing returns to step S01. In the case of prohibiting (YES in step S05), it is determined whether the number of unfinished sheets which are not printed is equal to or less than a predetermined value in step S11. When the number is equal to or less than the predetermined value (YES in step S11), the restricted operation is executed in step S06. When the number of unfinished sheets is more than the predetermined value (NO in step S11), the operation is stopped in step S07.

As described above, in the present embodiment, when an abnormal sound is detected in the image forming apparatus, the operation is not restricted based only on the occurrence (detection) of the abnormal sound, and whether the abnormal sound is such a sound that the operation of the image forming apparatus should be restricted is determined based on the subsequent secular change of the abnormal sound, and then since the operation is restricted when the sound is determined to be such an abnormal sound that the restriction should be carried out, there is no fear that the abnormal sound due to an external noise is erroneously determined to be caused by the deterioration of a component, and the degree of deterioration of the component generating the abnormal sound can be accurately determined, whereby the problem can be solved that the running cost is increased and the downtime of the apparatus is lengthened caused by restricting the operation based only on the occurrence (detection) of the abnormal sound.

In the above embodiment, a configuration is made so that the image forming apparatus 1 stores the audio data, detects the abnormal sound, and determines whether the cleaning blade 65 is deteriorated based on the subsequent secular change of the detected abnormal sound after the detection, thereby determining whether to restrict the operation of the image forming apparatus 1 and performing control according to the determination.

However, at least one of storage of audio data, detection of an abnormal sound, judgment on deterioration of the cleaning blade 65 based on the subsequent secular change of the detected abnormal sound, and determination of the execution of operation restriction may be done with a management apparatus (server) different from the image forming apparatus 1.

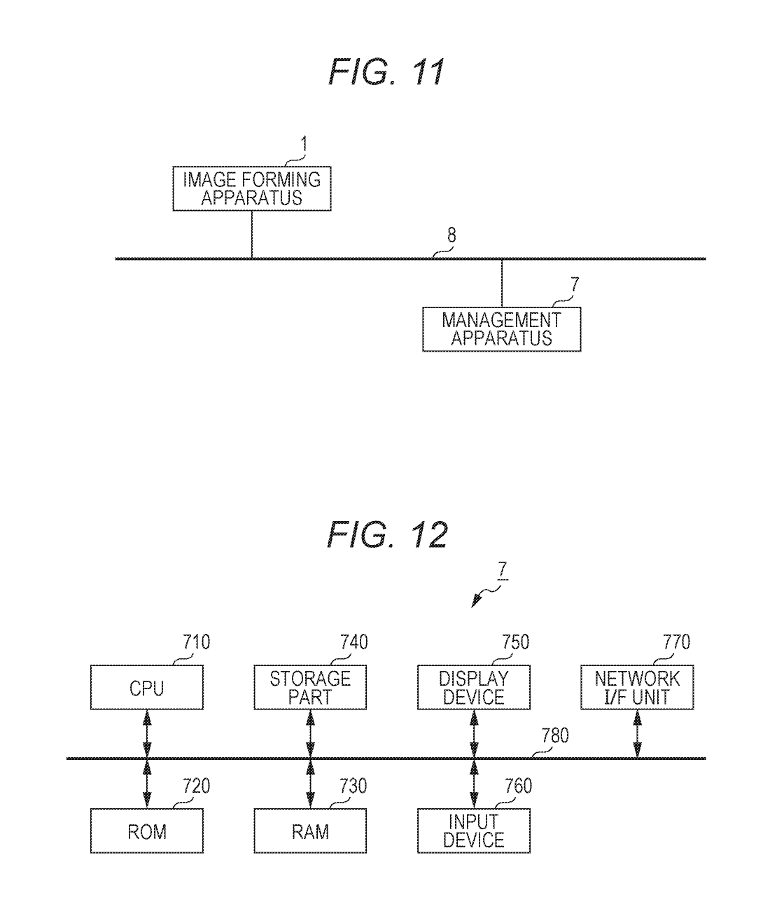

FIG. 11 is a configuration diagram of an abnormality determination system including such an image forming apparatus 1 and a management apparatus 7. The image forming apparatus 1 and the management apparatus 7 are mutually connectable via a network 8. The number of the image forming apparatus 1 may he one. Alternatively a plurality of image forming apparatuses 1 may be connected, and the management apparatus 7 may configured to manage a plurality of image forming apparatuses 1.

FIG. 12 is a block diagram showing an electrical configuration of the management apparatus 7.

The management apparatus 7 is made of a personal computer and includes a CPU 710, a ROM 720, a RAM 730, a storage part 740, a display device 750, an input device 760, a network interface unit (network I/F unit) 770, and the like, which are connected to each other via a bus 780 as shown in FIG. 12.

The CPU 710 loads programs stored in the ROM 720, the storage part 740, or the like into the RAM 730 and executes the programs, thereby performing overall control of the entire management apparatus 7.

The ROM 720 is a storage medium that stores a program to be executed by the CPU 710 and other data.

The RAM 730 is a storage medium that provides a work area when the CPU 710 operates according to an operation program.

The storage part 740 is composed of a storage medium such as a hard disk, and stores various management data, applications, and the like.

The display device 750 is composed of a liquid crystal display device or the like, and displays various messages, an input reception screen and a selection screen for the user, and the like.

The input device 760 is used for an input operation by a user, and is composed of a keyboard, a mouse, and the like.

The network interface unit 770 functions as a communication unit that exchanges data with the image forming apparatus 1 and the like via the network 8.

In the abnormality determination system shown in FIG. 11, the management apparatus 7 receives the audio data of the cleaning blade 65 from the image forming apparatus 1 via the network interface unit 770 and stores the data in the storage part 740. In this case, information on the secular change such as data according to model number, usage history, and the usage situation of the image forming apparatus 1 may also be stored. Such information may be collected from the image forming apparatus 1 or may be data collected from other image forming apparatuses of the same model number, or the data may be data further corrected with data of another group of image forming apparatuses.

While acquiring audio data and information on secular change from the management apparatus 7 periodically or at a predetermined timing, the image forming apparatus 1 checks the presence or absence of abnormal sounds, and estimates the deterioration state of the cleaning blade 65 on the basis of the secular change when an abnormal sound is detected, whereby when the blade is not deteriorated, that is, when the abnormal sound is temporary due to noise or the like, the image forming operation is permitted, and when the blade is deteriorated, the operation restriction including prohibition of the image forming operation may be performed. In this case, since the image forming apparatus 1 does not need to store audio data, the storage capacity of the storage part 22 can be prevented from reducing.

Further, on the basis of the audio data acquired from the image forming apparatus 1, the management apparatus 7 may be configured to perform determination of the presence or absence of an abnormal sound, estimation of the deterioration state of the cleaning blade 65 based on the secular change of the abnormal sound, and determination as to whether to permit or restrict the image forming operation based on the estimation result, etc., and further to notify the image forming apparatus 1 about the determined operation restriction, whereby the image forming apparatus 1 executes the notified operation restriction. In this case, the configuration of the image forming apparatus 1 can be simplified because the image forming apparatus 1 only has to transmit the audio data to the management apparatus 7 and to receive the operation restriction notification from the management apparatus 7 for restricting the operation. In addition, abnormal sounds of a plurality of image funning apparatuses 1 can be managed by one management apparatus 7.

In this manner, even in the case where at least one of storage of audio data, detection of an abnormal sound, judgment on deterioration of the cleaning blade 65 based on the subsequent secular change of the detected abnormal sound, and determination of the execution of operation restriction is performed by the management apparatus 7 different from the image forming apparatus 1, whether the sound is such a sound that the operation of the image forming apparatus should be restricted is determined based on the subsequent secular change of the abnormal sound instead of restricting the operation based only on the occurrence (detection) of the abnormal sound, and when the abnormal sound is one that deserves the restriction is determined, the operation is restricted, Accordingly there is no fear that an abnormal sound due to an external noise is erroneously determined to he caused by a component deterioration, the degree of deterioration of a component that has generated an abnormal sound can be determined with high accuracy, and the problem can be solved that the running cost is increased and the downtime of the apparatus is lengthened by restricting the operation based only on occurrence (detection) of an abnormal sound.

In the above embodiments, though the case where the cleaning blade 65 cleans the photoreceptor drum 63 has been exemplified, the cleaning blade 65 may clean the intermediate transfer body 60.

According to an embodiment of the item (1), when an abnormal sound is detected in an apparatus to be judged such as an image forming apparatus, it is determined whether the sound is such an abnormal sound that the operation of the apparatus to he judged should be restricted, in accordance with the subsequent secular change of the abnormal sound, instead of restricting the operation based only on the detection of the abnormal sound, and when the sound is determined to be such an abnormal sound that the operation should be restricted, the operation of the apparatus to be judged is restricted. Accordingly, there is no fear that an abnormal sound due to an external noise is erroneously determined to be caused by a component deterioration, and the degree of deterioration of a component that has generated an abnormal sound can be determined with high accuracy, whereby a problem can be solved such as an increase in the running cost or downtime of the apparatus due to the operation restriction based only on the occurrence (detection) of an abnormal sound.

According to an embodiment of the item (2), when such an abnormal sound that the operation should be restricted based on the secular change after the detection is assumed to be the first sound, the operation is restricted due to the first sound so that the restriction level of the operation is changed according to the level change of the sound after the abnormal sound is detected, and furthermore the operation is prohibited when the second sound having the different sound quality from the first sound is detected, whereby the presence of deterioration of the component in which the abnormal sound is generated can be more accurately determined and the operation according to the degree of deterioration of the component can be performed.

According to an embodiment of the item (3), the timing of the operation restriction of the apparatus to be judged can be appropriately switched when the loudness of the sound gradually increases beyond a predetermined value after the detection of the abnormal sound.

According to an embodiment of the item (4), the timing of the operation restriction of the apparatus to be judged can be appropriately switched when the occurrence frequency of the sound gradually increases beyond a predetermined value.

According to an embodiment of the item (5), the timing of the operation restriction of the apparatus to he judged can be appropriately switched when the frequency of the sound gradually changes beyond a predetermined value.

According to an embodiment of the item (6), audio data of the apparatus to be judged is acquired by a microphone.

According to an embodiment of the item (7), the operation of the image forming apparatus is restricted when an abnormal sound of the cleaning blade of the image forming apparatus is detected and the cleaning blade is estimated to have deteriorated based on the subsequent secular change of the abnormal sound. Accordingly there is no possibility of erroneously determining the abnormal sound due to an external noise to be caused by the deterioration of the cleaning blade, as in the case where the operation restriction is performed based only on the occurrence (detection) oldie abnormal sound of the cleaning blade, and thus the degree of deterioration of the cleaning blade that has generated the abnormal sound can be accurately estimated, whereby the problem that the running cost is increased and the downtime of the image forming apparatus becomes longer, which is caused by restricting the operation based only on the detection of the abnormal sound, can be solved.

According to an embodiment of the item (8), the printing operation is restricted when the cleaning blade is estimated to be deteriorated based on the abnormal sound and subsequent secular change of the cleaning blade.

According to an embodiment of the item (9), even when abnormal sound of the cleaning blade is detected and it is estimate that the cleaning blade is deteriorated, the scanner operation unrelated to the cleaning blade has no restriction and is executable.

According to an embodiment of the item (10), the printing operation level is changed according to the deterioration state of the cleaning blade.

According to an embodiment of the item (11), when an abnormal sound is detected during the image forming operation, whether the operation is permitted as it is determined according to the number of unfinished sheets to be printed.

According to an embodiment of the item (12), since the audio data is continued to be acquired until at least a sound corresponding to the blade curling of the cleaning blade is detected after the detection of the abnormal sound, the cleaning blade can be used until the life span end of the cleaning blade is reached.

According to an embodiment of the item (13), the operation of the image forming apparatus is restricted when abnormal sound of the cleaning blade of the image forming apparatus is detected and the cleaning blade is estimated to be deteriorated based on the subsequent secular change of the abnormal sound. Accordingly there is no possibility of erroneously determining the abnormal sound due to an external noise to be caused by the deterioration of the cleaning blade, as in the case where the operation restriction is performed based only on the occurrence (detection) of the abnormal sound of the cleaning blade, and thus the degree of deterioration of the cleaning blade that has generated the abnormal sound can be accurately estimated, whereby the problem that the running cost is increased and the downtime of the image forming apparatus becomes longer, which is caused by restricting the operation based only on the detection of the abnormal sound, can be solved. In addition, since the audio data acquired by the image forming apparatus is stored in a storage of the management apparatus, there is no need to store the audio data on the image forming apparatus side, and reduction of the capacity of the storage of the image forming apparatus can be prevented.

According to an embodiment of the item (14), at the time when the abnormal sound of the cleaning blade of the image forming apparatus is detected by the management apparatus, execution of the operation restriction of the image forming apparatus is determined and the image forming apparatus is notified of the determination when an abnormal sound is detected and the cleaning blade is estimated to he deteriorated based on the subsequent secular change of the abnormal sound. Since the image forming apparatus restricts the operation of itself on the basis of the notification, the problem that the running cost is increased and the downtime of the image forming apparatus is lengthened by restricting the operation based only on the detection of the abnormal sound, can be solved. In addition, since detection of an abnormal sound, estimation of deterioration of the cleaning blade based on the subsequent secular change of the abnormal sound, and determination of execution of operation restriction of the image forming apparatus are performed by the management apparatus, the configuration of the image forming apparatus can be simplified accordingly.

According to an embodiment of the item (15), it is possible to cause a computer of an abnormality determination apparatus having an audio data acquisitor for acquiring audio data of an apparatus to be judged whether to have abnormality to execute processing of detecting an abnormal sound on the basis of the audio data acquired by the audio data acquisitor, processing of determining whether the abnormal sound is such a sound that the operation of the apparatus to be judged should be restricted based on a subsequent secular change of the abnormal sound when an abnormal sound is detected, and processing of restricting the operation of the apparatus to be judged when the abnormal sound is determined to be such a sound that the operation should be restricted.

Although embodiments of the present invention have been described and illustrated in detail, the disclosed embodiments are made for purposes of illustration and example only and not limitation. The scope of the present invention should be interpreted by terms of the appended claims.

What is claimed is:

1. An abnormality determination apparatus comprising:
an audio data acquisitor that acquires audio data of an apparatus to be judged for determining presence or absence of abnormality;
an abnormal sound detector that detects an abnormal sound based on the audio data acquired by the audio data acquisitor; and
a hardware processor that determines whether the abnormal sound is such a sound that an operation of the apparatus to be judged should be restricted based on a subsequent secular change of the abnormal sound when the abnormal sound is detected by the abnormal sound detector, and restricts the operation of the apparatus to be judged when the hardware processor determines that the abnormal sound is such a sound that the operation of the apparatus to be judged should be restricted.

2. The abnormality determination apparatus according to claim 1, wherein
when the abnormal sound detected by the abnormal sound detector and determined to be such a sound that the operation should be restricted based on the subsequent secular change is assumed to be a first sound, as an operation restriction of the apparatus to be judged by the hardware processor, the operation is restricted according to the first sound so that a restriction level of an operation mode is changed according to a subsequent level change of the first sound, and when a second sound having a different sound quality from the first sound is detected, the operation is prohibited.

3. The abnormality determination apparatus according to claim 1, wherein
the secular change of the abnormal sound is a change in which a loudness of the sound gradually increases beyond a predetermined value, and
the hardware processor switches timing of an operation restriction based on the subsequent secular change of the abnormal sound.

4. The abnormality determination apparatus according to claim 1, wherein
the secular change of the abnormal sound is a change in which an occurrence frequency of the sound gradually increases beyond a predetermined value, and
the hardware processor switches timing of an operation restriction based on the subsequent secular change of the abnormal sound.

5. The abnormality determination apparatus according to claim 1, wherein
the secular change of the abnormal sound is a change in which a frequency of the sound gradually changes beyond a predetermined value, and
the hardware processor switches timing of an operation restriction based on the subsequent secular change of the abnormal sound.

6. The abnormality determination apparatus according to claim 1, wherein
the audio data acquisitor is a microphone.

7. An image forming apparatus comprising:
a photoreceptor or an intermediate transfer body;
a cleaning blade that removes a residue on the photoreceptor or the intermediate transfer body;
an audio data acquisitor that acquires audio data of the cleaning blade;
an abnormal sound detector that detects an abnormal sound of the cleaning blade based on the audio data acquired by the audio data acquisitor; and
a hardware processor that estimates deterioration of the cleaning blade based on a subsequent secular change of the abnormal sound when the abnormal sound of the cleaning blade is detected by the abnormal sound detector, and restricts an operation of the image forming apparatus when the hardware processor estimates that the cleaning blade is deteriorated.

8. The image forming apparatus according to claim 7, wherein
the operation restricted by the hardware processor is a printing operation.

9. The image forming apparatus according to claim 7, wherein
the hardware processor does not restrict the operation with respect to a scanner operation.

10. The image forming apparatus according to claim 8, wherein
the hardware processor changes a level of the printing operation according to a state of the deterioration of the cleaning blade.

11. The image forming apparatus according to claim 7, wherein
when the abnormal sound is detected by the detector during an image forming operation, the hardware processor determines whether to permit the operation as it is according to a number of unfinished sheets on which no image is formed.

12. The image forming apparatus according to claim 7, wherein
the abnormal sound detector acquires the audio data after detecting the abnormal sound at least until a sound corresponding to a blade curling of the cleaning blade is detected.

13. An abnormality determination system for an image forming apparatus comprising:
an image forming apparatus; and a management apparatus, wherein
the image forming apparatus comprises:
a photoreceptor or an intermediate transfer body;
a cleaning blade that removes a residue on the photoreceptor or the intermediate transfer body;
an audio data acquisitor that acquires audio data of the cleaning blade;
a transmitter that transmits the audio data acquired by the audio data acquisitor to the management apparatus;
a receptor that receives the audio data from the management apparatus;
an abnormal sound detector that detects an abnormal sound of the cleaning blade based on the audio data received by the receptor; and
a hardware processor that estimates deterioration of the cleaning blade based on a subsequent secular change of the abnormal sound when the abnormal sound of the cleaning blade is detected by the abnormal sound detector, and restricts an operation of the image forming apparatus when the cleaning blade is estimated to be deteriorated by the hardware processor, and
the management apparatus comprises:
a receptor that receives the audio data transmitted from the image forming apparatus;
a storage that stores the received audio data; and
a transmitter that transmits the audio data stored in the storage to the image forming apparatus.

14. An abnormality determination system for an image forming apparatus comprising:
an image forming apparatus; and a management apparatus, wherein
the image forming apparatus comprises:
a photoreceptor or an intermediate transfer body;
a cleaning blade that removes a residue on the photoreceptor or the intermediate transfer body;
an audio data acquisitor that acquires audio data of the cleaning blade; and
a transmitter that transmits the audio data acquired by the audio data acquisitor to the management apparatus,
the management apparatus comprises:
a receptor that receives the audio data transmitted from the image forming apparatus;
a storage that stores the received audio data;
an abnormal sound detector that detects an abnormal sound of the cleaning blade based on the audio data stored in the storage;
a hardware processor that estimates deterioration of the cleaning blade based on a subsequent secular change of the abnormal sound when the abnormal sound of the cleaning blade is detected by the abnormal sound detector, and determines execution of an operation restriction of the image funning apparatus when the hardware processor estimates that the cleaning blade is deteriorated; and
a notifier that notifies the image forming apparatus of the determined operation restriction of the image forming apparatus, and
the hardware processor of the image forming apparatus restricts an operation of the image forming apparatus based on a notification of the operation restriction of the image forming apparatus by the notifier.

15. A non-transitory recording medium storing a computer readable program causing a computer of an abnormality determination apparatus having an audio data acquisitor that acquires audio data of an apparatus to he judged for determining presence or absence of abnormality to perform:
detecting an abnormal sound based on the audio data acquired by the audio data acquisitor;
determining whether the abnormal sound is such a sound that an operation of the apparatus to be judged should be restricted based on a subsequent secular change of the abnormal sound when the abnormal sound is detected in the detecting; and.
performing control to restrict the operation of the apparatus to be judged when the abnormal sound is determined to be such a sound that the operation of the apparatus to be judged should be restricted in the determining.
